(19) United States
(12) Patent Application Publication
(10) Pub. No.: US 2009/0127028 A1
(43) Pub. Date: May 21, 2009

(54) Boost Valve for a Concrete Transfer Pump Lubricating System

(76) Inventor: Yangdong He, Guangdong (CN)

Correspondence Address: JOHN CHEN, ROOM 303, 3F, NO. 25, SEC. 1, CHANGAN E. ROAD, TAIPEI, 10441, TW

(21) Appl. No.: 11/912,390

(22) PCT Filed: Apr. 24, 2006
(86) PCT No.: PCT/CN06/00775

§ 371 Date: Oct. 24, 2007

(30) Foreign Application Priority Data
Apr. 25, 2005 (CN) 200510031479.6

(51) Int. Cl. F16N 7/30

(52) U.S. Cl. 184/55.1

(57) ABSTRACT

A boost valve for a concrete pump lubricating system is provided. The boost valve includes a valve body 1, a valve core 2, and a spring 3. An axial section of the valve core 2 is [symbol] -shape, and a rear cylinder 22 of the valve core 2 is connected to a check valve 21; a front valve cavity 15 of the valve body 1 is connected to a check valve 13, and an air orifice 12 and a grease distributing orifice 11 are opened in the valve body 1. When a pressure of an outlet is lower than a pressure of an inlet, lubrication grease is discharged from check valves (21, 13); when the pressure of the outlet is higher than that of the inlet, the lubrication grease pushes the valve core 2 to move rightwards, and the lubrication grease in the cavity 15 is pressurized and then discharged from the check valve 13; when the valve core 2 moves rightwards to pass the grease distributing orifice 11, the lubrication grease at. the inlet is discharged from the grease distributing orifice 11; when the grease is stopped supplying from the inlet, the spring 3 pushes the valve core 2 to restore an original position, so as to supply the grease to the booster cavity 15 from the check valve 21. The above features are helpful for improving the reliability and reducing the maintenance cost of the lubricating system.

### BACKGROUND OF THE INVENTION

1. Field of the Invention

The present invention relates to a boost valve for a concrete pump lubricating system.

2. Related Art

The lubricating system of concrete pump offers functions of lubricating and protecting pistons of concrete cylinders, bearings and seals of the distribution valve, and bearings and seals of the mixing device for the concrete pump. A current lubricating system may be an automatic lubricating system, formed by an automatic grease pump, a grease distributor, and joints and connecting oil pipes of different lubrication points; or it may be a manual lubricating system, formed by a manual grease pump and joints and connecting oil pipes of different lubrications points, or formed by a manual grease gun and joints of different lubrications points. The joints of different lubrication points include normal pipe joints, check valve joints, or oil nozzles without servo boost valves. When the concrete pump works in a high-pressure zone, due to the rising of the lubrication resistance at the lubrication points (e.g., the lubrication points at the outlet of the concrete pump and the pistons of the concrete pump), malfunctions often occur to the automatic lubricating system, for example, the lubrication grease cannot be fed into the lubrication points or even the grease pump or the grease distributor is stuck. In another aspect, the lubrication reliability of the manual lubricating system is often affected by the complicated working process, operators? quality, or system performances. The above problems often cause the operation of the lubricating system to be unstable, reduce the service life of the lubricated and protected objects, and even lead to the rising of the fault rate, thus causing adverse influences to the reliability of concrete pump, and increasing the manufacturing and maintenance costs of products.

### SUMMARY OF THE INVENTION

Directed to eliminating the defects in the prior art, the present invention provides a boost valve, which is capable of boosting the pressure of the lubrication grease supplied by a grease pump, and then injecting the lubrication grease into various lubrication points, so as to effectively overcome lubrication resistance, to improve working performance and reliability of concrete pump lubricating system, and meanwhile to reduce the maintenance cost.

The present invention provides a technical solution of a boost valve for a concrete pump lubricating system. Referring to FIG. 1, the valve includes a valve body 1, a valve core 2, and a spring 3. The valve core 2 is disposed in an inner cavity of the valve body 1, and has a [symbol] -shape axial section, and a sectional area of a front cylinder 23 is smaller than that of a rear cylinder 22.

The valve body 1 also has a valve cavity matching the size of the valve core 2, and the valve cavity is formed by a front valve cavity 15 and a rear valve cavity 14. The front valve cavity 15 is connected to a check valve 13 via a pipe at an outlet end, an air orifice 12 is opened radially at a position of the valve body 1 corresponding to the rear valve cavity 14, and a grease distributing orifice 11 is opened radially at a position of the valve body 1 corresponding to an inlet of the rear valve cavity 14.

The spring 3 is sleeved on the valve core 2 in the valve cavity of the valve body 1, one end of the spring 3 is attached to the rear cylinder 22 of the valve core 2, and the other end urges against a bottom surface of the rear valve cavity 14 for the valve body 1.

The working principle of the present invention is described as follows. As shown in FIG. 1, in the boost valve for the concrete pump lubricating system in the present invention, an A port is connected to the lubricating system, and a B port is connected to the lubrication points. The lubrication grease enters the boost valve via the A port, and then is discharged via the B port. When the pressure of the outlet of the boost valve (the pressure of the B port) is lower than that of the inlet (the pressure of the A port), the lubrication grease is directly discharged from the B port through a check valve 21 and the check valve 13; when the pressure of tie B port (the lubrication resistance) is higher than that of the A port, the pressure of the lubrication grease at the A port is applied on an end surface of the rear cylinder 22 for the valve core 2, and pushes the rear cylinder 22 to move rightwards, and then the front cylinder 23 of the valve core 2 pressurizes the lubrication grease in the E cavity 15, so as to discharge the lubrication grease from the B port through the check valve 13. When the valve core 2 moves rightwards to reach across the grease distributing orifice 11 on the valve body 1, the lubrication grease of the A port is discharged from the grease distributing orifice 11. When the grease is stopped supplying to the A port, the spring 3 pushes the valve core 2 to move lefitwards to restore an original position, and the lubrication grease of the A port is supplied to the E cavity 15 through the check valve 11, so as to make preparations for the next discharging process; and the air orifice 12 enables the valve cavity for accommodating the spring 3 to be communicated with the atmosphere, such that the sliding of the valve core 2 is not stuck.

The efficacy of the present invention lies in that the features of the boost valve significantly improve and enhance the reliability and working performance of the lubricating system, and thus reduce the maintenance cost.

### BRIEF DESCRIPTION OF THE DRAWINGS

FIG. 1 is a schematic structural view of the boost valve for concrete pump lubricating system according to the present invention.

### DETAILED DESCRIPTION OF THE INVENTION

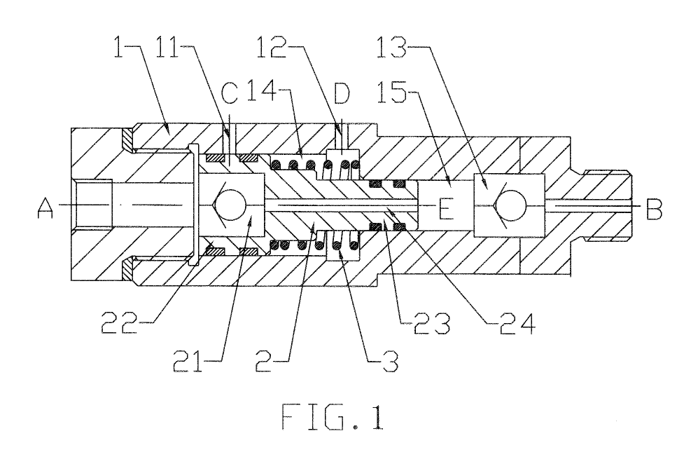

According to an embodiment of the present invention, the boost valve for concrete pump lubricating system shown in FIG. 1 includes a valve body 1, a valve core 2 with a central grease orifice 24, and a spring 3. The valve core 2 is disposed in the inner cavity of the valve body 1 coaxially and has a [symbol] -shape axial section, and the sectional area of front cylinder 23 of the valve core 2 is smaller than that of rear cylinder 22. A pipe of one end of the rear cylinder 22 other than the end connected to the front cylinder 23 is connected to a check valve 21 that adopts a M10×1 oil nozzle commercially available in the market.

The valve body 1 also has a valve cavity matching the size of the valve core 2. The valve cavity is formed by a front valve cavity 15 and a rear valve cavity 14. A pipe at the outlet end of the front valve cavity 15 is connected to the check valve 13 that adopts a M10×1 oil nozzle commercially available in the market. An air orifice 12 is opened radially at the position of the valve body 1 corresponding to the rear valve cavity 14, and a grease distributing orifice 11 is opened radially at the position of the valve body 1 corresponding to the inlet of the rear valve cavity 14.

The spring 3 is sleeved on the valve core 2, one end of the spring 3 is attached to the rear cylinder 22 of the valve core 2, and the other end urges against a bottom surface of a front end of the rear valve cavity 14 for the valve body 1. The specification of the spring 3 matches with that of the valve core 2.

What is claimed is:

1. A boost valve for a concrete pump lubricating system, comprising a valve body (1), a valve core (2), and a spring (3), wherein the valve core (2) is disposed in an inner cavity of the valve body (1), an axial section of the valve core (2) is [symbol] -shape, and a sectional area of a front cylinder (23) for the valve core (2) is smaller than that of a rear cylinder (22); the valve body (1) also has a valve cavity matching a size of the valve core (2), the valve cavity is formed by a front valve cavity (15) and a rear valve cavity (14), the front valve cavity (15) is connected to a check valve (13) via a pipe at an outlet end, an air orifice (12) is opened radially at a position of the valve body (1) corresponding to the rear valve cavity (14), and a grease distributing orifice (11) is opened radially at a position of the valve body (1) corresponding to an inlet of the rear valve cavity (14); the spring (3) is sleeved on the valve core (2) within the valve cavity of the valve body (1), one end of the spring (3) is attached to the rear cylinder (22) of the valve core (2), and the other end urges against a bottom surface of a front end of the rear valve cavity (14) for the valve body (1).

2. The boost valve for the concrete pump lubricating system as claimed in claim 1, wherein a pipe of one end of the rear cylinder (22) for the valve core (2) other than the end connected to the front cylinder (23) is connected to a check valve (21).
